(19) United States
(12) Patent Application Publication
(10) Pub. No.: US 2025/0209305 A1
(43) Pub. Date: Jun. 26, 2025

(54) METHODS AND SYSTEMS FOR PRESSURE GRADIENT PREDICTION IN OIL-WATER FLOWLINES EMPLOYING ARTIFICIAL INTELLIGENCE METHODS

(71) Applicant: SAUDI ARABIAN OIL COMPANY, Dhahran (SA)

(72) Inventors: James Ohioma Arukhe, Dhahran (SA); Mohammad Al Kadem, Qatif (SA)

(73) Assignee: SAUDI ARABIAN OIL COMPANY, Dhahran (SA)

(21) Appl. No.: 18/391,313

(22) Filed: Dec. 20, 2023

(51) Int. Cl. G06N 3/045; F17D 3/05; G06N 3/0985

(52) U.S. Cl. CPC G06N 3/045; F17D 3/05; G06N 3/0985

(57) ABSTRACT

A method for determining a pressure gradient in a pipeline conveying a multiphase mixture of, at least, oil and water. The method includes obtaining flow data from the pipeline conveying the multiphase mixture and obtaining a set of operation parameters related to a flow of the multiphase mixture in the pipeline. The method further includes determining, with a first artificial intelligence model and a second artificial intelligence model, a first and second predicted pressure gradient of the multiphase mixture in the pipeline, respectively, based on the flow data. The method further includes forming an aggregate pressure gradient from the first predicted pressure gradient and the second predicted pressure gradient and adjusting, with a pipeline controller, the set of operation parameters based on, at least, the aggregate pressure gradient.

### BACKGROUND

Oil and water, and other possible constituents (e.g., gas) can be conveyed as a multiphase fluid using a pipeline. In some instances, the oil and water mixture originates from a well. For example, hydrocarbon fluids are often found in hydrocarbon reservoirs located in porous rock formations far below the Earth's surface. Wells may be drilled to extract the hydrocarbon fluids from the hydrocarbon reservoirs and one or more pipelines may be used as part of the well or to transport extracted hydrocarbon fluids (e.g., oil and water mixture) to a storage, transportation, and/or processing facility.

The flow of a multiphase fluid, such as a mixture of oil and water, in a pipeline is affected by characteristics of the pipeline (e.g., diameter, internal surface roughness) and thermophysical properties of the multiphase fluid (e.g., temperature, viscosity). In some instances, a set of operation parameters (e.g., valve states) governs, within physical constraints, the flow of the multiphase fluid. Due to a complex interaction between operation parameters and their effect on the flow being further dependent on pipeline characteristics and thermophysical properties, selection of operation parameters to achieve an optimal flow condition is a difficult and laborious task, if performed at all. Accordingly, there exists a need to determine, preferably in real time, a pressure gradient along a pipeline, or a segment of pipeline, and a set of optimal operation parameters that yields the optimal flow condition.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

Embodiments disclosed herein generally relate to a method for determining a pressure gradient in a pipeline conveying a multiphase mixture of, at least, oil and water. The method includes obtaining flow data from the pipeline conveying the multiphase mixture and obtaining a set of operation parameters related to a flow of the multiphase mixture in the pipeline. The method further includes determining, with a first artificial intelligence model and a second artificial intelligence model, a first and second predicted pressure gradient of the multiphase mixture in the pipeline, respectively, based on the flow data. The method further includes forming an aggregate pressure gradient from the first predicted pressure gradient and the second predicted pressure gradient and adjusting, with a pipeline controller, the set of operation parameters based on, at least, the aggregate pressure gradient.

Embodiments disclosed herein generally relate to a system including a pipeline that conveys a multiphase mixture of, at least, oil and water. The system further includes a pipeline controller that can configure one or more configurable parameters of the pipeline, the one or more configurable parameters included in a set of operation parameters. The pipeline controller configured to: obtain flow data from the pipeline; determine, with a first artificial intelligence model and a second artificial intelligence model, a first and second predicted pressure gradient of the multiphase mixture in the pipeline, respectively, based on the flow data; form an aggregate pressure gradient from the first predicted pressure gradient and the second predicted pressure gradient; and adjust the set of operation parameters based on, at least, the aggregate pressure gradient.

Embodiments disclosed herein generally relate to a non-transitory computer-readable memory comprising computer-executable instructions stored thereon. The instructions, when executed on a processor, cause the processor to perform the following steps. The steps include obtaining flow data from a pipeline conveying a multiphase mixture of, at least, oil and water and obtaining a set of operation parameters related to a flow of the multiphase mixture in the pipeline. The steps further include determining, with a first artificial intelligence model and a second artificial intelligence model, a first and second predicted pressure gradient of the multiphase mixture in the pipeline, respectively, based on the flow data. The steps further include forming an aggregate pressure gradient from the first predicted pressure gradient and the second predicted pressure gradient and adjusting, with a pipeline controller, the set of operation parameters based on, at least, the aggregate pressure gradient.

Embodiments disclosed herein generally relate to methods and systems for predicting pressure gradients in oil-water flowlines using artificial intelligence (AI). One or more embodiments make use of two distinct AI models, namely, a radial basis function neural network (RBFNN) and a least squares support vector machine (LSSVM). These distinct AI models are used to accurately predict pressure gradients in pipelines conveying a multiphase mixture of oil and water. These AI models process flow data and operational parameters to generate individual predictions of the pressure gradient, which are then combined to form an aggregate pressure gradient. This aggregate gradient is used to adjust the pipeline's operation parameters, thereby optimizing the flow and overall efficiency of the pipeline system. One or more systems described herein are designed to continuously adapt and improve predictive accuracy with respect to pressure gradient predictions by learning from new operational data (e.g., newly acquired or real-time flow data). This adaptability ensures that these systems remain effective even as conditions within the pipeline change over time. One or more systems described herein also include a real-time monitoring feature, where sensors installed along the pipeline compare actual pressure gradients with predicted gradients. Discrepancies between these measurements can indicate potential issues, such as blockages or leaks, prompting timely maintenance actions.

Embodiments described herein may be implemented on, or include, a computer system such as an edge computing device for rapid processing and response.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency. The sizes and relative positions of elements in the drawings are not necessarily drawn to scale. For example, the shapes of various elements and angles are not necessarily drawn to scale, and some of these elements may be arbitrarily enlarged and positioned to improve drawing legibility. Further, the particular shapes of the elements as drawn are not necessarily intended to convey any information regarding the actual shape of the particular elements and have been solely selected for ease of recognition in the drawing.

FIG. 1 depicts a well environment in accordance with one or more embodiments.

FIG. 2 depicts a sectional view of a pipeline conveying a mixture of oil and water in accordance with one or more embodiments.

FIG. 3 depicts an input-output functional relationship through a set of artificial intelligence models.

FIG. 4 depicts a system in accordance with one or more embodiments.

FIG. 5 depicts a flowchart in accordance with one or more embodiments.

FIG. 6 depicts a neural network in accordance with one or more embodiments.

FIG. 7 depicts an optimization system in accordance with one or more embodiments.

FIG. 8 depicts a flowchart in accordance with one or more embodiments.

FIG. 9 depicts a system in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

It is to be understood that the singular forms “a,” “an,” and “the” include plural referents unless the context clearly dictates otherwise. For example, a “sensor” may include any number of “sensors” without limitation.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is to be understood that one or more of the steps shown in the flowcharts may be omitted, repeated, and/or performed in a different order than the order shown. Accordingly, the scope disclosed herein should not be considered limited to the specific arrangement of steps shown in the flowcharts.

Although multiple dependent claims are not introduced, it would be apparent to one of ordinary skill that the subject matter of the dependent claims of one or more embodiments may be combined with other dependent claims.

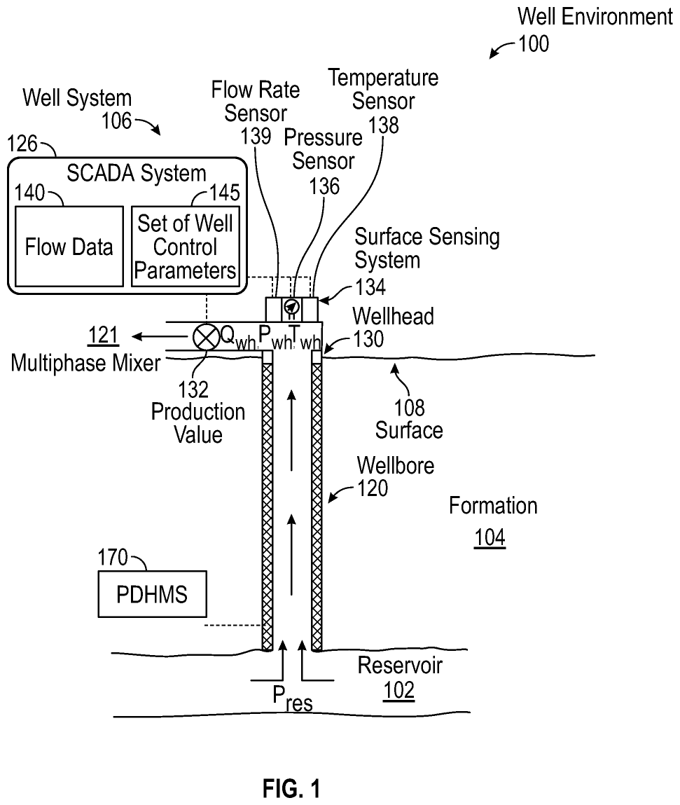

In the following description of FIGS. 1-9, any component described with regard to a figure, in various embodiments disclosed herein, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described with regard to a corresponding like-named component in any other figure.

In general, embodiments of the disclosure include systems and methods for predicting a pressure gradient of a multiphase mixture in a pipeline, or over a segment of a pipeline, in real time given some characteristics of the pipeline and the multiphase mixture. In one or more embodiments, the multiphase mixture is composed of, at least, oil and water. For example, a well of an oil and gas field with access to a hydrocarbon reservoir can extract fluid hydrocarbons, including oil and water, from the reservoir as a multiphase mixture. In general, for simplicity, the material output of a production well is a multiphase mixture. The produced mixture may be composed of a variety of solid, liquid, and gaseous constituents. For example, the produced mixture may contain solid particulates like sand, mineral precipitates such as pipe scale, and corroded pipe, liquid such as water, hydrocarbons in both liquid (i.e., oil) and gas states (gaseous hydrocarbons may simply be referred to as “gas”), and other gases like carbon dioxide (CO₂) and hydrogen sulfide (H₂S). The methods and systems described herein are applicable for many types of produced fluids, however a particular focus will be given to mixtures containing at least oil and water because, as will be described, a principal input of embodiments disclosed herein is an oil and water slip velocity.

A pressure gradient is a measure of the difference in pressure between two spatial locations, e.g., two cross-sections along a pipeline, the cross-sections orthogonal to an axial or longitudinal direction of the pipeline. The two spatial locations can be separated along the axial or longitudinal direction of the pipeline by a separation distance. In instances where the separation distance is fairly large (e.g., on the order of meters or kilometers) the pressure gradient represents an average pressure gradient along the bounded segment of pipeline. In other instances, the separation between the two spatial locations can be relatively small, even infinitesimally small, such that the pressure gradient can be considered a local or point pressure gradient. Integration of pointwise pressure gradients over a segment of a pipeline results in a difference in pressure when measured at the two bounding ends of the integration. Determination of a pressure gradient (or pressure gradients) in a pipeline is important to efficiently and safely operate the pipeline. Additionally, considerations of pressure gradient influences the design of systems employing pipelines with respect to aspects such as pipeline design, equipment sizing, and estimating overall system performance. Moreover, and as will be described herein, pressure gradient information, such as predicted pressure gradients, can be compared to measured pressure values to identify damaged and/or ill-performing pipelines (or pipeline segments). As such, embodiments disclosed herein, the embodiments producing at least a real time prediction of pressure gradient in a pipeline conveying a multiphase mixture of oil and water (and possibly other constituents), allow for improved decision-making processes (e.g., system design), the real time determination of optimal pipeline (and/or well) parameters, and the quick identification of damaged and/or ill-performing pipelines (or pipeline segments).

In general, the pressure gradient in a pipeline is influenced by physical characteristics of the pipeline itself (e.g., inner surface roughness, diameter), a condition of the pipeline (e.g., damaged), and thermophysical properties of the multiphase mixture conveyed by the pipeline (e.g., oil viscosity). In one or more embodiments, the pressure gradient is predicted using two artificial intelligence (AI) models based on, at least, flow data, the flow data including physical characteristics of the pipeline and thermophysical properties of the multiphase fluid. In one or more embodiments, the two AI models are a least squares support vector machine (LSSVM) and a radial basis function neural network (RBFNN). These AI models will be described in greater detail later in the instant disclosure. In one or more embodiments, the two AI models each predicted a pressure gradient (or pressure gradients) in a pipeline conveying a multiphase mixture of oil and water based on the flow data, resulting in two pressure gradient predictions that are aggregated according to an aggregation function to form an aggregated pressure gradient prediction (“aggregated pressure gradient”). In one or more embodiments, the two AI models may further be informed by a set of operation parameters that define configurable aspects of a well (e.g., a well from which the multiphase mixture is extracted) and/or the pipeline. For example, the set of operation parameters may include well control parameters, the well control parameters defining the state of hardware governing fluid flow in the well system or along any portion of the pipeline (e.g., a valve configured to be opened or closed, or partially closed). In one or more embodiments, based on the aggregate pressure gradient, a command may be sent to update the set of operation parameters to new values or states to achieve a particular goal. Goals include, but are not limited to: maintaining the flow of the multiphase fluid to a certain category of flow that results in reduced friction and thus reduced pumping requirements; optimizing the flow rate of the flow or a particular constituent of the flow (e.g., maximizing extracted oil given some fixed or constrained parameters such as pumping rate and gas-lift); and maximizing the production of a desired hydrocarbon (e.g., oil).

FIG. 1 shows a schematic diagram in accordance with one or more embodiments. More specifically, FIG. 1 illustrates a well environment (100) that includes a hydrocarbon reservoir (“reservoir”) (102) located in a subsurface formation (“formation”) (104) and a well system (106). In some implementations, a multiphase mixture of oil and water is produced, or originates, from a well. As such, FIG. 1 illustrates a well environment (100) to contextualize these implementations. However, it is emphasized that embodiments disclosed herein generally relate to the prediction of pressure gradient of a multiphase mixture of, at least, oil and water in a pipeline, where the pipeline need not necessarily be associated with a well or well environment (100). The formation (104) may include a porous formation that resides underground, beneath the Earth's surface (“surface”) (108). In the case of the well system (106) being a hydrocarbon well, the reservoir (102) may include a portion of the formation (104). The formation (104) and the reservoir (102) may include different layers (referred to as subterranean intervals or geological intervals) of rock having varying characteristics, such as varying degrees of permeability, porosity, capillary pressure, and resistivity. In other words, a subterranean interval is a layer of rock having approximately consistent permeability, porosity, capillary pressure, resistivity, and/or other characteristics. For example, the reservoir (102) may be an unconventional reservoir or tight reservoir in which fractured horizontal wells are used for hydrocarbon production. Generally, a “complex” reservoir may be any reservoir that exhibits physical characteristics or internal qualities which vary substantially on either spatial or temporal scales. In the case of the well system (106) being operated as a production well, the well system (106) may facilitate the extraction of hydrocarbons (or “hydrocarbon production,” or simply “production” when appropriate based on context) from the reservoir (102).

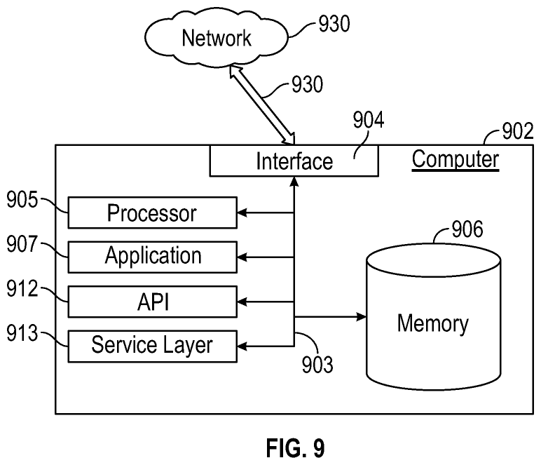

In some embodiments, the well system (106) includes a wellbore (120) and a well controller (e.g., Supervisory Control and Data Acquisition (SCADA) system (126)). The control system may control various operations of the well system (106), such as well production operations, well completion operations, well maintenance operations, and reservoir monitoring, assessment and development operations. In some embodiments, the control system includes a computer system that is the same as or similar to that of the computer system depicted in FIG. 9 with its accompanying description.

The wellbore (120) may include a bored hole that extends from the surface (108) into a target zone (i.e., a subterranean interval) of the formation (104), such as the reservoir (102). An upper end of the wellbore (120), terminating at or near the surface (108), may be referred to as the “up-hole” end of the wellbore (120), and a lower end of the wellbore, terminating in the formation (104), may be referred to as the “down-hole” end of the wellbore (120). The wellbore (120) may facilitate the circulation of drilling fluids during drilling operations, the flow of a multiphase mixture (121) (e.g., oil and water) produced from the well from the subsurface to the surface (108) during production operations, the injection of substances (e.g., water) into the formation (104) or the reservoir (102) during injection operations, the placement of monitoring devices (e.g., logging tools) into the formation (104) or the reservoir (102) during monitoring operations (e.g., during in situ logging operations).

In some embodiments, a casing (not shown) is installed in the wellbore (120). For example, the wellbore (120) may have a cased portion and an uncased (or “open-hole”) portion. The cased portion may include a portion of the wellbore having casing (e.g., casing pipe and casing cement) disposed therein. The uncased portion may include a portion of the wellbore not having casing disposed therein. In embodiments having a casing, the casing defines a central passage that provides a conduit for the transport of tools and substances through the wellbore (120). For example, the central passage may provide a conduit for lowering logging tools into the wellbore (120), a conduit for the flow of the multiphase mixture (121) (e.g., oil and water) from the reservoir (102) to the surface (108), or a conduit for the flow of injection substances (e.g., water) from the surface (108) into the formation (104). In some embodiments, the well system (106) includes production tubing installed in the wellbore (120). The production tubing may provide a conduit for the transport of tools and substances through the wellbore (120). The production tubing may, for example, be disposed inside casing. In such an embodiment, the production tubing may provide a conduit for some or all of the multiphase mixture (121) (e.g., oil and water) passing through the wellbore (120) and the casing.

In some embodiments, various control components and sensors are disposed downhole along the wellbore (120). For example, in one or more embodiments, an inflow control valve (ICV) may be disposed along the wellbore. An ICV is an active component usually installed during well completion. The ICV may partially or completely choke flow into a well. Generally, multiple ICVs may be installed along the reservoir section of a wellbore. Each ICV is separated from the next by a packer. Each ICV can be adjusted and controlled to alter flow within the well and, as the reservoir depletes, prevent unwanted fluids from entering the wellbore. In addition, the control components and sensors may further include a subsurface safety valve (SSSV). The SSSV is designed to close and completely stop flow in the event of an emergency. Generally, an SSSV is designed to close on failure. That is, the SSSV requires a signal to stay open and loss of the signal results in the closing of the valve. In one or more embodiments, a permanent downhole monitoring system (PDHMS) (170) is secured downhole. The PDHMS (170) consists of a plurality of sensors, gauges, and controllers to monitor subsurface flowing and shut-in pressures and temperatures. As such, a PDHMS (170) may indicate, in real-time, the state or operating condition of subsurface equipment and the fluid flow. In one or more embodiments, the PDHMS (170) may further measure and monitor temperature and pressure within the reservoir (102) as well as other properties not listed.

In some embodiments, the well system (106) includes a wellhead (130). The wellhead (130) may include a rigid structure installed at the “up-hole” end of the wellbore (120), at or near where the wellbore (120) terminates at the Earth's surface (108). The wellhead (130) may include structures (called “wellhead casing hanger” for casing and “tubing hanger” for production tubing) for supporting (or “hanging”) casing and production tubing extending into the wellbore (120). The multiphase mixture (121) may flow through the wellhead (130), after exiting the wellbore (120), including, for example, the casing and the production tubing. In some embodiments, the well system (106) includes flow regulating devices that are operable to control the flow of substances into and out of the wellbore (120). For example, the well system (106) may include one or more production valves (132) that are operable to control the flow of the multiphase mixture (121). For example, a production valve (132) may be fully opened to enable unrestricted flow of the multiphase mixture (121) from the wellbore (120), the production valve (132) may be partially opened to partially restrict (or “throttle”) the flow of the multiphase mixture (121) from the wellbore (120), and production valve (132) may be fully closed to fully restrict (or “block”) the flow of the multiphase mixture (121) from the wellbore (120).

In some embodiments, the wellhead (130) includes a choke assembly. For example, the choke assembly may include hardware with functionality for opening and closing the fluid flow through pipes in the well system (106). Likewise, the choke assembly may include a pipe manifold that may lower the pressure of fluid traversing the wellhead. As such, the choke assembly may include a set of high pressure valves and at least two chokes. These chokes may be fixed or adjustable or a mix of both. Redundancy may be provided so that if one choke has to be taken out of service, the flow can be directed through another choke. In some embodiments, pressure valves and chokes are communicatively coupled to the well controller (e.g., SCADA system (126)).

Keeping with FIG. 1, in some embodiments, the well system (106) includes a surface sensing system (134). The surface sensing system (134) may include sensors for sensing characteristics of substances, including the multiphase mixture (121), passing through the wellbore (120) at various stages. The characteristics may include, for example, pressure, temperature and flow rate of multiphase mixture (121) flowing through the wellhead (130), or other conduits of the well system (106), after exiting the wellbore (120).

In some embodiments, the surface sensing system (134) includes a surface pressure sensor (136) operable to sense the pressure of the multiphase mixture (121) flowing through the well system (106) and its components after it exits the wellbore (120). The surface pressure sensor (136) may include, for example, a wellhead pressure sensor that senses a pressure of the multiphase mixture (121) flowing through or otherwise located in the wellhead (130). In some embodiments, one or more additional pressure sensors can be disposed downstream along a pipeline to acquire pressure data as a function of length, or distance traversed by the multiphase mixture (121). In these embodiments, pressure gradients can be determined between two or more pressure sensors. In some embodiments, the surface sensing system (134) includes a surface temperature sensor (138) operable to sense the temperature of the multiphase mixture (121) flowing through the well system (106), after it exits the wellbore (120). The surface temperature sensor (138) may include, for example, a wellhead temperature sensor that senses a temperature of the multiphase mixture (121) flowing through or otherwise located in the wellhead (130), referred to as “wellhead temperature” (T_{wh}). In one or more embodiments, one or more properties of the multiphase mixture (121) can be derived from—or are functionally or tabularly related to—measured quantities like temperature. For example, in one or more embodiments, one or more samples of oil extracted from the multiphase mixture (121) are used to relate oil viscosity to temperature, for example, through characterization performed using a viscometer. Once developed, for example, through laboratory testing, such a relationship can be used to determine oil viscosity given a temperature measurement acquired from a temperature sensor.

In some embodiments, the surface sensing system (134) includes a flow rate sensor (139) operable to sense the flow rate of the multiphase mixture (121) flowing through the well system (106), after it exits the wellbore (120). The flow rate sensor (139) may include hardware that senses a flow rate of the multiphase mixture (121) (Q_{wh}) passing through the wellhead (130). In one or more embodiments the flow rate sensor (139) is a multiphase flow meter (MPFM). The MPFM monitors the flow rate of the multiphase mixture (121) by constituent. That is, the MPFM may detect the instantaneous amount of oil and water. As such, the MPFM indicates percent water cut (% WC) and, in some instances, can further be used to determine an oil and water slip velocity. Additionally, the MPFM may measure pressure and fluid density. The MPFM may further include, or make use of, the surface pressure sensor (136) and the surface temperature sensor (138).

In accordance with one or more embodiments, during operation of the well system (106), the well controller (e.g., SCADA system (126)) collects and records flow data (140) for the well system (106). The flow data (140) may include, for example, a record of measurements of wellhead pressure (P_{wh}) (e.g., including flowing wellhead pressure), wellhead temperature (T_{wh}) (e.g., including flowing wellhead temperature), wellhead volume flow rate (Q_{wh}) over some or all of the life of the well (106), water cut data, oil and water slip velocity, and oil viscosity; where one or more of these quantities may be derived, or related to, one or more other quantities.

In some embodiments, the measurements are recorded in real-time, and are available for review or use within seconds, minutes, or hours of the condition being sensed (e.g., the measurements are available within 1 hour of the condition being sensed). In such an embodiment, the flow data (140) may be referred to as “real-time” flow data (140). Real-time flow data (140) may enable an operator of the well (106) to assess a relatively current state of the well system (106), and make real-time decisions regarding development of the well system (106) and the reservoir (102), such as on-demand adjustments in regulation of the multiphase mixture (121) from the well.

The various valves, pressure gauges and transducers, sensors, and flow meters depicted of a well may be considered devices of an oil and gas field. As described, these devices may be disposed both above and below the surface of the Earth. These devices are used to monitor and control components and sub-processes of an oil and gas field. It is emphasized that the plurality of oil and gas field devices described in reference to FIG. 1 are non-exhaustive. Additional devices, such as electrical submersible pumps (ESPs) (not shown) may be present in an oil and gas field with their associated sensing and control capabilities. For example, an ESP may monitor the temperature and pressure of a fluid local to the ESP and may be controlled through adjustments to ESP speed or frequency.

The plurality of oil and gas field devices may be distributed, local to the sub-processes and associated components, global, connected, etc. The devices may be of various control types, such as a programmable logic controller (PLC) or a remote terminal unit (RTU). For example, a programmable logic controller (PLC) may control valve states, pipe pressures, warning alarms, and/or pressure releases throughout the oil and gas field. In particular, a programmable logic controller (PLC) may be a ruggedized computer system with functionality to withstand vibrations, extreme temperatures, wet conditions, and/or dusty conditions, for example, around a well system (106). With respect to an RTU, an RTU may include hardware and/or software, such as a microprocessor, that connects sensors and/or actuators using network connections to perform various processes in the automation system. As such, a distributed control system may include various autonomous controllers (such as remote terminal units) positioned at different locations throughout the oil and gas field to manage operations and monitor sub-processes. Likewise, a distributed control system may include no single centralized computer for managing control loops and other operations.

In accordance with one or more embodiments, and as depicted in FIG. 1, the well controller can be a supervisory control and data acquisition (SCADA) system (126). A SCADA system (126) is a control system that includes functionality for device monitoring, data collection, and issuing of device commands. The SCADA system (126) enables local control at an oil and gas field as well as remote control from a control room or operations center. To emphasize that the SCADA system (126) may monitor and control the various devices of an oil and gas field, dashed lines connecting some of the oil and gas field devices to the SCADA system (126) are shown in FIG. 1.

In review, and in accordance with one or more embodiments, a plurality of field devices is disposed throughout a well system (106). A field device may be disposed below the surface (108), e.g., a component of the PDHMS (170), or located above the surface (108) and considered part of the well surface sensing system (134). Field devices disposed below the surface may further measure properties or characteristics of the reservoir (102). Generally, field devices can measure or sense a property, control a state or process of the well system (106), or provide both sensory and control functionalities. For example, a state of a valve may include an indication of whether the valve is open or closed. In some instances, the state of a valve may be given by some percentage of openness (or closedness). As such, a field device, which may be the valve itself, can determine and transmit the state of the valve and therefore act as a sensor or sensory device. Further, a field device, which may be the valve itself, can alter or change the state of the valve by receiving a signal from the SCADA system (126). Sensed or measured properties of the multiphase mixture (121) can be stored and/or collected, along with other properties and/or characteristics, as flow data (140).

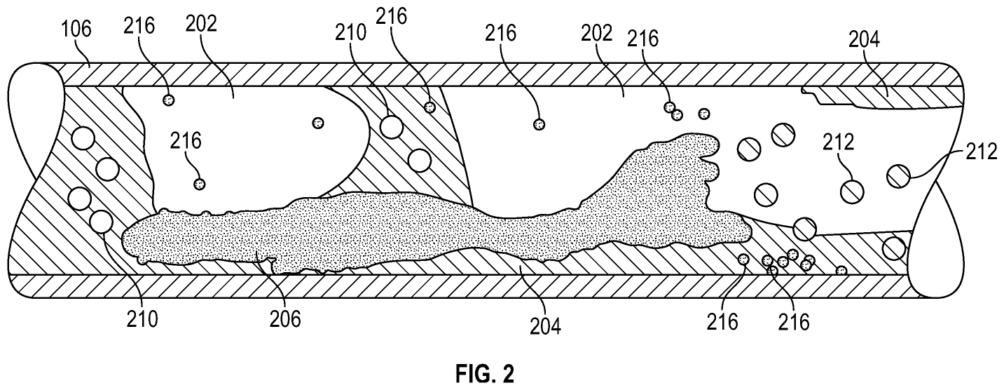

As stated, embodiments disclosed herein generally relate to the prediction of pressure gradient of a pipeline conveying a multiphase mixture (121) of oil and water (and possibly other constituents). The pipeline may be associated with or part of a well system (106), however, this need not be the case. FIG. 2 depicts a sectional view of a pipeline carrying a multiphase mixture of oil and water. In some instances, the multiphase mixture can have additional constituents such as gas. FIG. 2 depicts a multiphase mixture composed of gas (202), water (204), and oil (206). The various constituents of the multiphase mixture may be distributed within the pipeline in a myriad of ways. As a non-limiting example, gas (202) may be enclosed by liquids (water or oil) forming bubbles (210). Or, in contrast, liquid droplets, such as oil droplets (216) and water droplets (212), may be dispersed in the gas (202) to form a mist. In general, the state of the multiphase mixture may be described using broad classifications. That is, in one or more embodiments, the multiphase mixture may be categorized as “bubbly,” “annular,” “churn,” “mist,” “stratified,” or other designations (flow classes) based on the distribution of the constituents and their relative quantities. The state of the multiphase mixture may be transient such that any assignment of flow class may change with time. Some flow classes may be more desirable than others. For example, a first flow class may require a smaller pressure gradient to convey the multiphase mixture at the same flow rate when compared to a second flow class. That is, some flow classes may induce higher levels of friction or other irreversible flow losses in the pipeline. As another example, a first flow class may result in greater oil production relative to water production (or gas production) compared to a second flow class. As another example, some flow classes may be associated with high magnitudes of vibrations or other flow-induced forces on the pipeline that can cause damage to the pipeline. In summary, a given flow class can be desired over another flow class and adjustment of operation of a pipeline (or a well) can affect the flow class.

Various pipeline devices, such as valves (and oil and gas field devices, like those shown in FIG. 1 (and others not shown)), can govern the behavior (e.g., flow class, flow rate) of a multiphase fluid conveyed in a pipeline. Therefore, the operation of the pipeline, in terms of at least efficiency and safety, is directly affected, and may be altered by, at least some, of the pipeline devices. Generally, complex interactions between pipeline devices, characteristics of the pipeline (e.g., diameter, inner surface roughness), and thermophysical properties (e.g., oil viscosity) of the multiphase mixture exist such that configuring pipeline devices (and/or oil and gas field devices) for optimal pipeline operation is a difficult and laborious task. Further, often factors that affect the flow of the multiphase mixture change, or are otherwise transient, with time. As such, a set of operation parameters that controls the behavior of the pipeline may need to be continually altered and/or updated to maintain an optimal flow condition (e.g., a desired flow class) of the flow of the multiphase mixture. One informative metric that may be useful in determining the changes to a set of operation parameters to improve pipeline efficiency, among other goals (e.g., identification of damaged pipeline segments, pipeline and overall system design), is the pressure gradient of the multiphase mixture flowing in the pipeline. As previously defined, the pressure generally describes the difference in pressure between two spatial locations along a pipeline (typically in an axial or longitudinal direction). In some instances, the separation distance between the two spatial locations is infinitesimally small such that the pressure gradient is determined at a point in the pipeline. Notably, embodiments described herein can be applied to multiple segments (including the whole length of the pipeline) or points to determine the pressure gradient at these segments or points. Generally, the pressure gradient is sensitive to the physical characteristics of the pipeline and thermophysical properties of the multiphase mixture. In some instances, the pressure gradient may further be sensitive to the state or setting of one or more pipeline devices (or oil and gas field devices). As such, the pressure gradient (and, more generally, the behavior) of a multiphase mixture flowing in a pipeline can be, in some instances, affected by configurable aspects of the pipeline (and/or well) where these configurable aspects are comprised by a set of operation parameters.

Conventional methods for determining or predicting a pressure gradient in a pipeline can usually be categorized as one of empirical models, mechanistic models, and computational models (e.g., simulation). Empirical models, such as the Beggs and Brill model or the Hagedorn and Brown model, are often based on experimental data and express the pressure gradient as a function of various parameters, including flow rates, fluid properties, and pipeline geometry. However, they may not provide accurate predictions under different conditions than those used to develop the model, limiting their generalizability. Mechanistic models aim to capture the physics of the multiphase flow, such as the interactions between the multiphase mixture (and/or specific constituents) and the pipe wall, the effect of gravity, and the friction between the various constituents of the multiphase mixture. While, in general, mechanistic models can provide more accurate predictions than empirical models, they can be complex and computationally intensive. Additionally, mechanistic models may require detailed information about the flow of the multiphase fluid and its properties, which may not always be available or are prohibitively expensive to obtain. Finally, computational models (e.g., computation fluid dynamics (CFD), finite element analysis (FEA), etc.) can simulate the flow of a multiphase mixture in a pipeline, typically by solving a discretized and conditionally-simplified system of Navier-Stokes equations. However, computational models are computationally demanding (at least relative to the other conventional methods and the embodiments of this disclosure) and require substantial time and resources. Additionally, computational models require detailed knowledge about the flow condition and properties of the multiphase mixture.

Limitations of the conventional methods can be summarized as follows. Conventional methods lack generalizability. That is, conventional methods often do not perform well when applied to conditions (e.g., flow conditions, set of operation parameters, a specific regime of thermophysical properties, etc.) that are different from those under which they were developed. Some methods, for example, computational methods, require significant computational resources and time. Finally, many conventional methods require detailed information about the flow conditions and properties of the multiphase mixture, which may not be readily available or may change over time (i.e., transient).

In accordance with one or more embodiments, flow data from a pipeline conveying a multiphase mixture of, at least, oil and water are processed with two artificial intelligence (AI) models to determine or predict the pressure gradient in, or over a segment of, the pipeline. As will be described below, these AI models are capable of learning complex, nonlinear relationships between variables and can provide quick and accurate predictions once trained, even in the presence of noise or uncertainty. Furthermore, the AI models are less computationally demanding than computational models such as those employing CFD, making them a more efficient solution. Thus, the use of AI models for pressure gradient prediction allows for quick (e.g., real time) determinations with minimal computational expense, and improved efficiency and optimization in pipeline processes such as oil production processes.

Artificial intelligence, broadly defined, is the extraction of patterns and insights from data. The phrases “artificial intelligence”, “machine learning”, “deep learning”, and “pattern recognition” are often convoluted, interchanged, and used synonymously throughout the literature. This ambiguity arises because the field of “extracting patterns and insights from data” was developed simultaneously and disjointedly among a number of classical arts like mathematics, statistics, and computer science. For consistency, the term artificial intelligence (AI), will be adopted herein, however, one skilled in the art will recognize that the concepts and methods detailed hereafter are not limited by this choice of nomenclature.

In accordance with one or more embodiments, the first AI model is a least squares support vector machine (LSSVM) and the second AI model is a radial basis function neural network (RBFNN). More details regarding these models are provided later in the disclosure. In general, these AI models are configured according to one or more “hyperparameters” which further describe the models. For example, hyperparameters providing further detail about the RBFNN may include, but are not limited to, the number of layers in the network and regularization strength. The selection of hyperparameters may be informed through evaluation of a model performance metric (e.g., mean absolute error (MAE), mean squared error (MSE), mean absolute percentage error (MAPE), etc.) when the model is tested on a set of data not seen while training the model and with known output quantities (e.g., a validation set). The processes of training, validating, and testing the AI models is described in greater detail later in the disclosure.

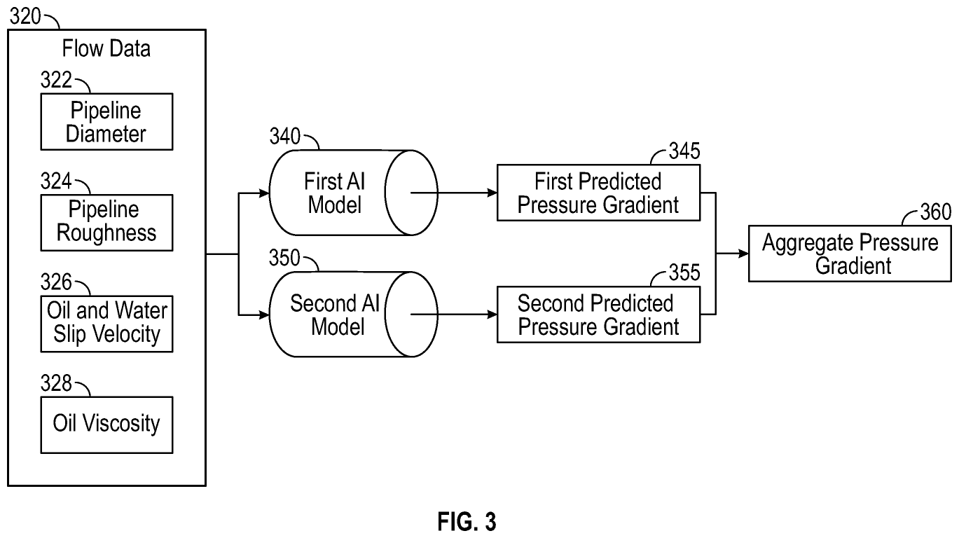

In accordance with one or more embodiments, FIG. 3 depicts the prediction of the pressure gradient in, or over a segment of, a pipeline conveying a multiphase mixture. As depicted in FIG. 3, two artificial intelligence (AI) models, namely, a first AI model (340) and a second AI model (350) are each used to determine a predicted pressure gradient. Specifically, the first AI model (340) is a LSSVM and the second AI model (350) is a RBFNN. The LSSVM and RBFNN are each capable of modeling complex, nonlinear relationships between variables, which can improve the accuracy of pressure gradient predictions compared to conventional methods (as described above). In fact, these AI models can process large amounts of data more quickly and efficiently than conventional methods, making them suitable for real-time prediction tasks. By providing accurate and timely predictions of pressure gradients, these AI models can support more informed decision-making, leading to more efficient operations and optimized oil production. Additionally, once trained, these AI models can be continually updated and improved as new data is collected, allowing them to adapt to changing conditions in the pipeline.

As seen in FIG. 3, the first AI model (340) and the second AI model (350) process, as inputs, flow data (320). In accordance with one or more embodiments, the flow data (320) includes a diameter of the pipeline (322) under consideration (or the diameter of the pipeline over a segment or at a point where the pressure gradient is being determined), an indication of the roughness of the inner surface of the pipeline (324), a measurement of the oil and water slip velocity (326), and the oil viscosity (328). Pipeline diameter (322) is used as an input because it can affect the pressure gradient. For example, generally, and for a given flow rate, a smaller diameter pipeline will have a pressure gradient that is higher relative to a larger diameter pipeline. Pipeline roughness (324) is a measure of the texture of the internal surface of the pipeline. Higher roughness can increase friction, leading to higher pressure gradients. Oil and water slip velocity represents the relative velocity between the oil and water phases in the pipeline. Oil viscosity represents the viscosity or “thickness” of the oil. It can impact the flow behavior and the pressure gradient in a pipeline. For example, higher viscosity can lead to higher pressure gradients.

In accordance with one or more embodiments, and as seen in FIG. 3, each of the first AI model (340) and the second AI model (350) process the flow data (320) and output a prediction for the pressure gradient. Specifically, the first AI model (340) returns a first predicted pressure gradient (345) and the second AI model (350) returns a second predicted pressure gradient (355). In accordance with one or more embodiments, the first and second pressure gradients (345, 355) are aggregated to form an aggregate pressure gradient (360) using an aggregation function. Various aggregation functions can be used. For example, in one implementation, the aggregation function forms the aggregate pressure gradient (360) as the average of the first predicted pressure gradient (345) and the second predicted pressure gradient (355). In other implementations, the possible values of an instance of flow data (320) are said to span a data space (e.g., hyperspace) and the data space is partitioned into two or more regimes. For example, in one or more embodiments, the data space is partitioned into a first regime and a second regime, the first and second regimes being mutually exclusive and their union exhausting the data space. In such an implementation, the first predicted pressure gradient (345) can be selected and used as the aggregate pressure gradient (360) when the input flow data (320) resides within the first regime. Similarly, in such an implementation, the second predicted pressure gradient (355) is selected and used as the aggregate pressure gradient (360) when the input flow data (320) resides within the second regime. That is, in one or more implementations, the first and second AI models (340, 355) can be said to have complementary modalities of discrimination, where one model is more apt (or more accurate) at predicting the pressure gradient under a certain set of conditions (i.e., encompassed and defined by a regime in the data space) relative to the other model. In other implementations, the data space is partitioned into three regimes, where, for example, the aggregate pressure gradient (360) is set equal to the first predicted pressure gradient (345) when the input flow data (320) resides within the first regime, the aggregate pressure gradient (360) is set equal to the second predicted pressure gradient (355) when the input flow data (320) resides within the second regime, and the aggregate pressure gradient (360) is set equal to an average of the first and second predicted pressure gradients (345, 355) when the input flow data (320) resides within the third regime. In another example, the aggregation function consists of the weighted average of the first predicted pressure gradient (345) and the second predicted pressure gradient (355) where the weights are based on historical accuracy. For example, the weights assigned to each model may be given according to a regime in which the input resides. In these examples, one or more regimes (or subspaces of the data space) can be defined (i.e., boundary of regime established and weights assigned to the regime) based on the accuracy of first AI model (340) and second AI model (350) on historical data (e.g., training data). In another example, a confidence level is associated with at least one of the first predicted pressure gradient (345) and the second predicted pressure gradient (355). In this example, the aggregation function can consist of a weighted average of the first predicted pressure gradient (345) and the second predicted pressure gradient (355), where the weights correspond to the confidence level of at least one of the predictions. For example, in one or more embodiments, the weight assigned to the first predicted pressure gradient (345) and the weight assigned to the second predicted pressure gradient (355) when the aggregation function is a weighted average is w₁ and w₂, respectively. Further, the confidence level associated with the first predicted pressure gradient (345) and the confidence level associated with the second predicted pressure gradient (355) is c₁ and c₂, respectively, where c₁ and c₂ need not sum to 1. Using this notation, in one or more embodiments, the weights used in the aggregation function are determined using the softmax function as

$${w}_{1} = \frac{exp ( {c}_{1} )}{exp ( {c}_{1} ) + exp ( {c}_{2} )} and {w}_{2} = \frac{exp ( {c}_{2} )}{exp ( {c}_{1} ) + exp ( {c}_{2} )} .$$

In one or more embodiments, the first AI model (340) and the second AI model (340) operate synergistically. That is, the first AI model (340) and the Second AI model (350) do not operate independently (e.g., in parallel). For example, in one or more embodiments, the first AI model (340) and the second AI model (350) operate in a hierarchical where one model's output informs the focus or parameter settings of the other. For example, in some embodiments, the first AI model (340) processes flow data (320) to determine a first predicted pressure gradient (345). Then, the flow data (320) and the first predicted pressure gradient (345) are processed, as inputs, by the second AI model (350) to produce the second predicted pressure gradient (355). In this case, the second predicted pressure gradient (355) can be directly taken as the aggregate pressure gradient (360). In other embodiments, the first AI model (340) processes flow data (320) to determine a first predicted pressure gradient (345) and rather than passing the first predicted pressure gradient (345) as an input to the second AI model (350), the first predicted pressure gradient (345) is used to inform (or adjust) the parameters of the second AI model (350). For example, consider notation where the first AI model (340) is represented as a function ƒ₁ that produces an output y₁ given an input x, the function parameterized by parameters β₁ (i.e., y₁=ƒ₁(x:β₁)). Likewise, consider a notation where the second AI model (350) is represented as a function ƒ₂ that produces an output y₂ given an input x, the function parameterized by parameters β₂ (i.e., y₂=ƒ₂(x:β₂)). Thus, in some embodiments, the informed nature of the second AI model (350), being informed by the first AI model (340), can be represented mathematically as y₂=ƒ₂(x:β₂(y₁)). That is, the parameterization of the second AI model (350) is dependent on the output (i.e., first predicted pressure gradient (345)) of the first AI model (340). In one or more embodiments, the input and/or parameterization of the first AI model (340) is based on the output of the second AI model (350) and, similarly, the input and/or parameterization of the second AI model (350) is based on the output of the first AI model (340). In these embodiments, an initial (or null) output can be used to initialize either of the first or second AI models (340, 350) and the subsequent output can be used to as input (and/or parameterization) to the other AI model. This may form an iterative process of interaction between the first AI model (340) and second AI model (350) that proceeds until a stopping criterion such as convergence in the predicted pressure gradient(s) (i.e., predicted pressure gradient does not change substantially (e.g., compared to some threshold) between iterations). In one or more embodiments, synergistic operation of the first AI model (340) and the second AI model (350) is realized through a joint training procedure. Training of AI models is described in greater detail below. However, here it may be said that in one or more embodiments joint training of the first AI model (340) and the second AI model (350) consists of structuring the loss function that guides the training process such that errors in the prediction of the first AI model (340) can affect (adjust) the parameterization of the second AI model (350) and vice versa. In summary, the synergistic operation of the first AI model (340) and the second AI model (350) can be implemented in a variety of ways in accordance with one or more embodiments, such as using the outputs of one model as inputs or contextual modifiers (e.g., dependent parametrization) for the other, joint training procedure, and/or iterative processes that continually refines the model predictions. Further, the aggregate pressure gradient (360) can be formed using one or more of the first and second predicted pressure gradients. For example, in instances where the first and second AI models (340, 350) interact iteratively, the aggregate pressure gradient (360) can be set equal to either the first or second predicted pressure gradient (345, 355) upon determination of convergence in the predictions.

Benefits of synergistic operation are described with respect to specific AI model types. Consider the case where the first AI model (340) is a radial basis function neural network (NN) and the second AI model (350) is a least square support vector machine (LSSVM). Generally, an RBFNN excels in handling complex, non-linear relationships such as those often prevalent in multiphase fluid dynamics, effectively mapping intricate patterns in the data. The LSSVM, in contrast, is known for its structured risk minimization principle promoting robustness against overfitting and enhancing generalization capabilities. Thus, synergistic operation of these AI models allows for a nuanced understanding and prediction of pressure gradients, leveraging the strengths of both models in a way that their independent operation cannot achieve. While synergistic use of these models can leverage their individual strengths, application of these models, namely RBFNN and LSSVM, for prediction of pressure gradient in oil-water pipelines is non-obvious. The RBFNN and LSSVM, as noted above, have distinct characteristics and strengths, and their integration for pressure gradient prediction in oil-water pipelines is a nuanced decision. This approach goes beyond a simple selection among AI models, involving a creative integration tailored to the specific complexities of oil-water pipeline systems. The non-obviousness is underscored by the fact that existing models in the field do not suggest or imply the benefits of this particular integration for this purpose. As such, embodiments disclosed herein not only address the complex dynamics of multiphase flow but also offer a tailored, efficient solution for predicting pressure gradients in oil-water pipelines.

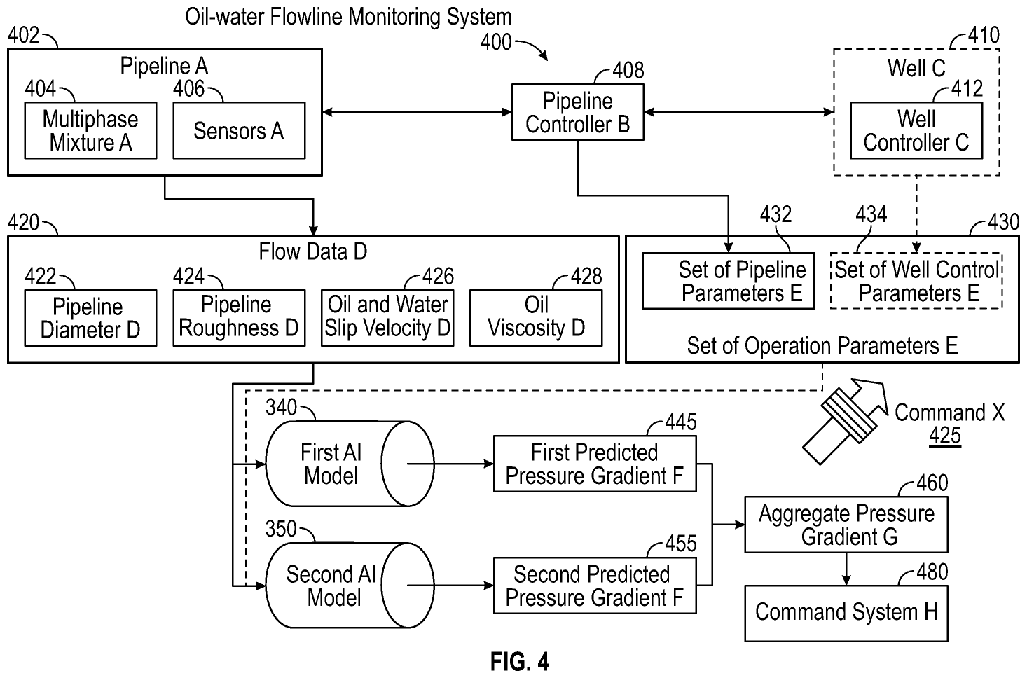

In some implementations, methods and systems of the instant disclosure are effectuated as an oil-water flowline monitoring system. Turning to FIG. 4, FIG. 4 depicts an instance of an oil-water flowline monitoring system (400) in accordance with one or more embodiments. As seen in FIG. 4, the oil-water flowline monitoring system (400) includes a pipeline (e.g., Pipeline A (402)). The pipeline conveys a multiphase mixture (e.g., Multiphase Mixture A (404)). Further, one or more sensors (e.g., Sensors A (406)) are disposed on the pipeline and considered part of the oil-water flowline monitoring system (400). The sensors may include one or more temperature sensors, pressure sensors, vibration sensors, flow rate sensors (including multiphase flowrate devices (e.g., MPFM)), and a viscometer, among other sensors.

Sensor data, and other data related to the pipeline (e.g., Pipeline A (402)) is collected as flow data (e.g., Flow Data D (420)). As seen in FIG. 4, flow data (e.g., Flow Data D (420)) can include characteristics of the pipeline such as the pipeline diameter (e.g., Pipeline Diameter D (422)), pipeline roughness (e.g., Pipeline Roughness D (424)), as well as properties the multiphase mixture (e.g., Multiphase Mixture A (404)) conveyed by the pipeline such as the viscosity of the oil in the multiphase mixture (e.g., Oil Viscosity D (428)). The flow data can also include a measurement of the oil and water slip velocity of the multiphase mixture (e.g., Oil and Water Slip Velocity D (426)). As seen, the flow data can include quantities that can vary with time (e.g., oil and water slip velocity, oil viscosity) and quantities that can, possibly, vary spatially (e.g., pipeline diameter, pipeline roughness). As such, an instance (or a single “input” from the perspective of the first and second AI models (340, 350)) may be composed of the measured or known properties of the pipeline and multiphase mixture at a given location and time. In some implementations, quantities of the flow data (e.g., Flow Data D (420)) are derived from other measurements, the measurements acquired with the pipeline sensors. For example, in one or more embodiments, oil viscosity is determined using a measured temperature and/or pressure of the multiphase mixture.

The pipeline (e.g., Pipeline A (402)) is communicatively coupled to a pipeline controller (e.g., Pipeline Controller B (408)). The pipeline controller can, at least, receive, monitor, and process data received from the sensors (e.g., Sensors A (406)) associated with the pipeline and further monitor and set the values of configurable parameters that control operation of the pipeline. Configurable pipeline parameters are defined as a set of pipeline parameters (e.g., Set of Pipeline Parameters E (432)). In some embodiments, the pipeline controller (e.g., Pipeline Controller B (408)) includes a computer system that is the same as or similar to that of computer system depicted in FIG. 9.

In one or more embodiments, the oil-water flowline monitoring system (400) also includes a well (e.g., Well C (410)) such as that described with reference to FIG. 1. FIG. 4 uses a dashed block to represent the well (e.g., Well C (410)) because, in general, the pipeline (e.g., Pipeline A (402)) need not be directly associated with a well. The well (e.g., Well C (410)) can include a well controller (e.g., Well Controller C (412)). The well controller can, at least, receive, monitor, and process data received from one or more sensors associated with the well and further monitor and set the values of configurable parameters that control operation of the well. Configurable well parameters are defined as a set of well control parameters (e.g., Set of Well Control Parameters E (434)). In one or more embodiments, the well controller controls various operations of the well (e.g., Well C (410)), such as well production operations, well completion operations, well maintenance operations, and monitoring, assessment and development operations. In some embodiments, the well controller includes a computer system that is the same as or similar to that of computer system depicted in FIG. 9 with its accompanying description. In accordance with one or more embodiments, the set of well control parameters (e.g., Set of Well Control Parameters E (434)) define and assign states to devices disposed within the well, which may include valves, such as production valve and inflow control valves near the surface, controllers of a permanent downhole monitoring system and associated devices, one or more tools for logging, one or more choke assemblies, and one or more electrical submersible pumps.

Although FIG. 4 depicts a separate pipeline controller (e.g., Pipeline Controller B (408)) and well controller (e.g., Well Controller C (412)), in instances where the oil-water flowline monitoring system (400) includes a well (e.g., Well C (410)), these controllers need not be separate entities. In practice, a single controller of the oil-water flowline monitoring system (400) can be used to perform the operations of the pipeline controller and/or the well controller, when applicable. In other implementations, the pipeline controller (e.g., Pipeline Controller B (408)) and the well controller (e.g., Well Controller C (412)) are communicatively coupled such that, for example, the pipeline controller can issue commands to—and effectively control—the well controller. In general, the set of pipeline parameters (e.g., Set of Pipeline Parameters E (432)) and the set of well control parameters (e.g., Set of Well Control Parameters E (434)), when applicable, can be referred to as a set of operation parameters (e.g., Set of Operation Parameters E (430)). That is, when the oil-water flowline monitoring system (400) does not include a well (e.g., Well C (410)), the set of operation parameters (e.g., Set of Operation Parameters E (430)) includes only the set of pipeline parameters (e.g., Set of Pipeline Parameters E (432)). In instances where the oil-water flowline monitoring system (400) includes a well (e.g., Well C (410)), a strict distinction between pipeline parameters and well control parameters may not be possible. In such cases, the reference of a set of operations parameters (e.g., Set of Operation Parameters E (430)) can be used without undue ambiguity to refer to a configurable parameter of the oil-water flowline monitoring system (400) without further indicating if said parameter is associated with a well or a pipeline.

Continuing with FIG. 4, the flow data (e.g., Flow Data D (420)) is passed to and processed by the first AI model (340) and the second AI model (350) to produce a first predicted pressure gradient (e.g., First Predicted Pressure Gradient F (445)) and a second predicted pressure gradient (e.g., Second Predicted Pressure Gradient F (455)), respectively. In one or more embodiments, the first and the second AI models (340, 350) are further informed by the set of operation parameters (e.g., Set of Operation Parameters E (430)). For example, different trained AI models, or parameterizations of the AI models, can be used based on the set of operation parameters. In other embodiments, the first and second AI models (340, 350) receive as inputs the set of operation parameters, in addition to the flow data. As described with reference to FIG. 3, the first and second pressure gradient predictions (e.g., First Predicted Pressure Gradient F (445) and Second Predicted Pressure Gradient F (455)) are aggregated to form an aggregate pressure gradient (e.g., Aggregate Pressure Gradient G (460)). In some implementations, the aggregation function depends on the set of operation parameters (e.g., Set of Operation Parameters E (430)) and/or the flow data (e.g., Flow Data D (420)).

In one or more embodiments, the flow data (e.g., Flow Data D (420)) and set of operation parameters (e.g., Set of Operation Parameters E (430)), are continuously monitored by the oil-water flowline monitoring system (400) (e.g., using sensors and/or controllers such as Sensors A (406) and Pipeline Controller B (408)). Accordingly, the aggregate pressure gradient (e.g., Aggregate Pressure Gradient G (460)) may be determined at any given moment in time, or across a predefined interval of time.

In accordance with one or more embodiments, the aggregate pressure gradient (e.g., Aggregate Pressure Gradient G (460)) is transmitted automatically and in real-time over a distributed network or through a physical mechanism for data transfer such as fiber optic cables via a command system (e.g., Command System H (480)). The command system may be a controller such as an RTU or PLC and/or the pipeline controller (e.g., Pipeline Controller B (408)) itself. The command system may further include a computer that is the same as or similar to that of computer system depicted in FIG. 9 with its accompanying description. Based on the aggregate pressure gradient (e.g., Aggregate Pressure Gradient G (460)), the command system (e.g., Command System H (480)) transmits a signal or command to update one or more parameter values, the one or more parameters belonging to the set of operation parameters (e.g., Set of Operation Parameters E (430)). The command to update or modify the state of the set of operation parameters is represented by Command X (425) in FIG. 4.

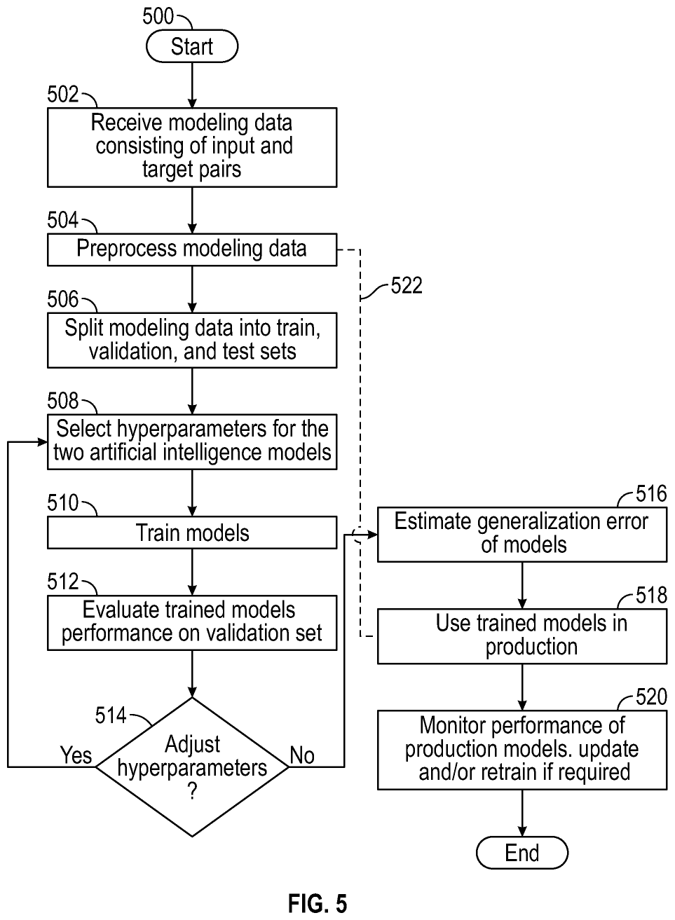

FIG. 5 depicts the general process of training and selecting the hyperparameters (also known as model tuning) for the first and second AI models (340, 350), in accordance with one or more embodiments. The processes shown in FIG. 5 may be applied to obtain the trained the AI models (340, 350) individually, or in conjunction with one another. To start, as shown in Block 502, modelling data is received. The modelling data consists of input and target pairs. For example, to train the first and second AI models (340, 350), an input and target pair may consist of flow data and an associated pressure gradient. In one or more embodiments, the modelling data, or input-target pairs of flow data and pressure gradient, are acquired from historical operation data.

Keeping with FIG. 5, in one or more embodiments, the modelling data is preprocessed as depicted by Block 504. Preprocessing, at a minimum, includes altering the modelling data so that it is suitable for use with AI models. For example, numericalizing categorical data or removing data entries with missing values. Other typical preprocessing methods are normalization and imputation. Information surrounding the preprocessing steps is saved for potential later use. For example, if normalization is performed then a computed mean vector and variance vector are retained. This allows future modelling data to be preprocessed identically. Values computed and retained during preprocessing are referred to herein as preprocessing parameters. One with ordinary skill in the art will recognize that a myriad of preprocessing methods beyond numericalization, removal of modelling data entries with missing values, normalization, and imputation exist. Descriptions of a select few preprocessing methods herein do not impose a limitation on the preprocessing steps encompassed by this disclosure.

As shown in Block 506, the modelling data is split into training, validation, and test sets. In some embodiments, the validation and test set may be the same such that the data is effectively only split into two distinct sets. In some instances, Block 506 may be performed before Block 504. In this case, it is common to determine the preprocessing parameters, if any, using the training set and then to apply these parameters to the validation and test sets.

In Block 508, the hyperparameters for the first and second AI models (340, 350) are selected. Once selected, the first and second AI models (340, 350) are trained using the training set of the modelling data according to Block 510. Common training techniques, such as early stopping, adaptive or scheduled learning rates, and cross-validation may be used during training without departing from the scope of this disclosure.

During training, or once trained, the performance of the trained first and second AI models (340, 350) are evaluated using the validation set as depicted in Block 512. Recall that, in some instances, the validation and test sets are the same. Generally, performance is measured using a function which compares the predictions of the trained AI models to the given targets. A commonly used comparison function is the mean-squared-error function, which quantifies the difference between the predicted value and the actual value. However, one with ordinary skill in the art will appreciate that many more comparison functions exist and may be used without limiting the scope of the present disclosure. Examples of other comparison functions may include, but are not limited to the mean absolute error function, the coefficient of determination, and the mean absolute percentage error function. In one or more embodiments, more than one comparison function is used to evaluate the performance of the trained first and second AI models (340, 350).

At Block 514, a determination is made as to whether the hyperparameters of the first and second AI models (340, 350) needs to be altered. If the performance of the trained first and second AI models (340, 350), as measured by a comparison function on the validation set (Block 512), is suitable, then the trained first and second AI models (340, 350) are accepted for use in a production setting. As such, in Block 518, the trained first and second AI models (340, 350) are used in production. However, before the AI models are used in production, a final indication of their performance can be acquired by estimating the generalization error of the trained AI models, as shown in Block 516. Generalization error is an indication of the trained AI models' performance on new, or un-seen data. Typically, the generalization error is estimated using the comparison function, as previously described, using the modelling data that was partitioned into the test set.

At Block 514, if the performance of the trained first and second AI models (340, 350) are not suitable, the hyperparameters may be altered (i.e., return to Block 508) and the training process is repeated. There are many ways to alter the hyperparameters in search of suitable trained AI model performances. These include, but are not limited to: selecting new sets of hyperparameters from previously defined sets; randomly perturbing or randomly selecting new hyperparameters; using a grid search over the available hyperparameters; and intelligently altering hyperparameters based on the observed performance of previous models (e.g., a Bayesian hyperparameter search). Once suitable performance is achieved, the training procedure is complete, and the generalization error of the trained first and second AI models (340, 350) are estimated according to Block 516.

As depicted in Block 518, the trained first and second AI models (340, 350) are used “in production”-which means, as previously stated, that the trained AI models are used to process a received input without having a paired target for comparison. It is emphasized that the inputs received in the production setting, as well as for the validation and test sets, are preprocessed identically to the manner defined in Block 504 as denoted by the connection (522), represented as a dashed line in FIG. 5, between Blocks 518 and 504.

In accordance with one or more embodiments, the performance of the trained first and second AI models (340, 350) are continuously monitored in the production setting (520). If performance of one or more of these AI models is suspected to be degrading, as observed through in-production performance metrics (i.e., comparison functions), the affected, degraded, or ill-performing AI model may be updated. An update may include retraining the AI model, by reverting to Block 508, with the newly acquired modelling data from the in-production recorded values appended to the training data. An update may also include recalculating any preprocessing parameters, again, after appending the newly acquired modelling data to the existing modelling data.

While the various blocks in FIG. 5 are presented and described sequentially, one of ordinary skill in the art will appreciate that some or all of the blocks may be executed in different orders, may be combined or omitted, and some or all of the blocks may be executed in parallel. Furthermore, the blocks may be performed actively or passively.

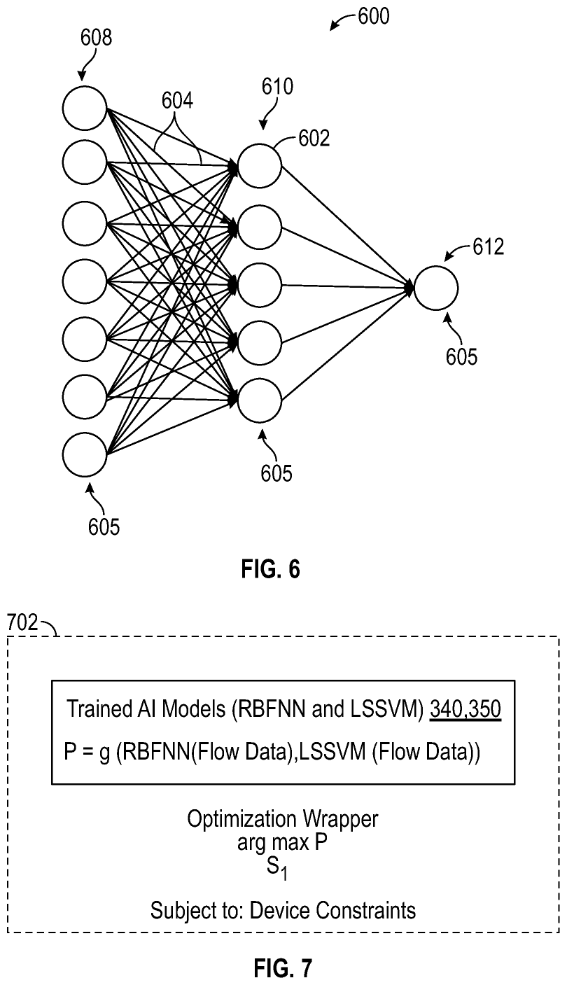

In accordance with one or more embodiments, the first AI model (340) is a radial basis function neural network (RBFNN). A diagram of a generalized RBFNN is shown in FIG. 6. At a high level, a RBFNN (600) may be graphically depicted as being composed of nodes (602), where here any circle represents a node, and edges (604), shown here as directed lines. The nodes (602) may be grouped to form layers (605). FIG. 6 displays three layers (608, 610, 612) of nodes (602) where the nodes (602) are grouped into columns, however, the grouping need not be as shown in FIG. 6. The edges (604) connect the nodes (602). Edges (604) may connect, or not connect, to any node(s) (602) regardless of which layer (605) the node(s) (602) is in. That is, the nodes (602) may be sparsely and residually connected. A RBFNN (600) typically has three layers (605), where the first layer (608) is considered the “input layer,” the last layer (612) is the “output layer,” and the intermediate layer (610) is usually described as a “hidden layer.”

Nodes (602) and edges (604) can carry additional associations. Generally, for a RBFNN (600), each node (602) of the hidden layer (610) is associated with a radial basis function. The radial basis functions are commonly taken to be Gaussian and of the form

$$ρ = exp ( - β {‖ x - c ‖}^{2} ) , \qquad EQ . 1$$

where x is an input to the function and can be a vector (e.g., a vector representation of an instance of flow data), c is commonly referred to as the center vector and centers the radial basis function in some space defined by the possible values of x, and β is a constant. While EQ. 1 depicts the use of the L₂ norm (“Euclidean norm”), other norms such as the L₁ norm (“Manhattan norm”) and Mahalanobis distance can be used without limitation. Each node (602) in the hidden layer can be indexed, for example, with the index of i, such that the output of the RBFNN (600) can be represented mathematically as

$$ψ ( x ) = {\sum }_{i = 1}^{N} {α}_{i} ρ ( x : {c}_{i} , {β}_{i} ) , \qquad EQ . 2$$

where x is the input vector, where each element of the input vector is a node (602) of the input layer (608), N is the number of nodes in the hidden layer (i.e., the number of radial basis functions considered), αᵢ is a weighting factor for the i^{th} basis function, ρ represents the radial basis function acting on the input vector x, the radial basis function parameterized by an i^{th} center vector cᵢ and constant βᵢ.

The training procedure for the RBFNN (600) can include determining values for one or more trainable parameters (e.g., one or more of βᵢ, cᵢ, and αᵢ (for each of the N radial basis functions)). To begin training, trainable parameters may be initially given a random value, assigned a value according to a prescribed distribution, assigned manually, or assigned a value by some other assignment mechanism. Once these trainable parameters have been initialized, the RBFNN (600) may act as a function, such that it may receive inputs and produce an output. As such, at least one input is propagated through the RBFNN (600) to produce an output. Recall, that a given set of modelling data will be composed of inputs and associated target(s), where the target(s) represent the “ground truth,” or the otherwise desired output. In accordance with one or more embodiments, the input of the RBFNN (600) is the flow data including a pipeline diameter, pipeline roughness, oil and water slip velocity, and oil viscosity. The RBFNN (600) output is compared to the associated input data target(s). The comparison of the RBFNN (600) output to the target(s) is typically performed by a so-called “loss function;” although other names for this comparison function such as “error function,” “misfit function,” and “cost function” are commonly employed. Many types of loss functions are available, such as the mean-squared-error function, however, the general characteristic of a loss function is that the loss function provides a numerical evaluation of the similarity between the RBFNN (600) output and the associated target(s). Comparison functions discussed with respect to FIG. 5 can each be considered a loss function. The loss function may also be constructed to impose additional constraints on the values assumed by the trainable parameters, for example, by adding a penalty term, which may be physics-based, or a regularization term. Generally, the goal of a training procedure is to alter the trainable parameters to promote similarity between the RBFNN (600) output and associated target(s) over the given data set (e.g., training data set). Thus, the loss function is used to guide changes made to the trainable parameters, typically through a two-step process where the first process involves selection of the center vectors (e.g., random selection, unsupervised methods such as k-means clustering, etc.) and the second step involves fitting the remaining trainable parameters using the loss function.

In accordance with one or more embodiments, the second AI model (350) is a least squares support vector machine (LSSVM). In alignment with the described use of the second AI model (350) of the present disclosure, a LSSVM, once trained, may be considered a function which accepts an input and produces an output. As such, the LSSVM may receive, as an input, flow data (and possibly a set of operation parameters) and return a predicted pressure gradient. To better understand a LSSVM, a general description of a support vector machine (SVM) regressor is provided as follows. In general, a support vector machine (SVM) regressor may be decomposed into two parts. First, a support vector machine (SVM) regressor transforms the input data to a feature space. The feature space is usually a higher dimensional space than the space of the original input data. The transformation is performed using a function from a family of functions often referred to in the literature as “kernel” functions. Many kernel functions exist and kernel functions may be created, usually through a combination of other kernel functions, according to a specific use-case. The choice of kernel function for a support vector machine (SVM) regressor is a hyperparameter of the SVM. Kernel functions possess certain mathematical properties. While a complete description of kernel functions and their associated properties exceeds the scope of this disclosure, it is stated that an important property of kernel functions is that they are amenable to the so-called “kernel trick.” The kernel trick allows for distances to be computed between pairs of data points in the feature space without actually transforming the data points from the original input space to the feature space. The second part of a SVM consists of parameterizing a hyperplane in the feature space. The hyperplane is described by a set of weights, {w₀, w₁, . . . , wₙ}. The hyperplane represents the predicted value of the SVM regressor given an input and can be written as

$$y = {w}_{0} + {\sum }_{j = 1}^{M} {w}_{j} {x}_{j} , \qquad EQ . 3$$

where y is the value of the hyperplane and xⱼ is a value on an axis j of the feature space where the feature space has M dimensions. Note that in some implementations a support vector machine regressor and associated kernel, the weight w₀ may be included in the summation. The set of weights may be described using a vector w. Likewise, a data point in the feature space may be described as a vector x. Incorporating w₀ into the weight vector and using vector notation, the prediction for a data point indexed by k may be written as

$${y}_{k} = {w}^{T} {x}_{k} . \qquad EQ . 4$$

To determine the values of the weights for a support vector machine regressor, also known as training the support vector machine model, the following optimization problem is solved:

$$min \frac{1}{2} {‖ w ‖}^{2} \qquad EQ . 5$$

$$subject to : \vert {y}_{k} - {w}^{T} {x}_{k} \vert \leq ϵ , ∀ k in training data ,$$

where ε is an error term, set by a user and may be considered another hyperparameter of the support vector machine model. From EQ. 4, it is seen that w^{T}xₖ represents the predicted value, or in the context of the present disclosure, the predicted pressure gradient, for a training data point xₖ. As such, the constraint |yₖ−w^{T}xₖ|≤ε in EQ. 5 indicates that the difference between the actual value yₖ and the predicted value w^{T}xₖ must be smaller than some pre-defined error ε. While this is an acceptable practice, it is noted that the hyperplane determined by EQ. 5 is quite sensitive to outlier data values. This is because the entirety of the hyperplane may need to be altered, often adversely, in order to accommodate the constraint of EQ. 5 for an outlier data point, or the value of ε may have to be increased. To mitigate the negative effects of outliers in the data, and more generally to produce a support vector machine regressor with greater predictive power, EQ. 5 is altered to included slack terms ξⱼ and a regularization term λ as follows:

$$min ( \frac{1}{2} {‖ w ‖}^{2} + λ {\sum }_{k = 1}^{Q} \vert {ξ}_{k} \vert ) \qquad EQ . 6$$

$$subject to : \vert {y}_{k} - {w}^{T} {x}_{k} \vert \leq ϵ + \vert {ξ}_{k} \vert , ∀ k .$$

In EQ. 6, there are Q data points in the training set and the data points are indexed by k. For each training data point there is a slack term ξₖ which can alleviate the constraint. As such, the constraint may be satisfied, for example, for outlier data points, without altering the hyperplane. If the slack terms were allowed to grow without limitation, the slack terms would obviate the constraint. To counter this, the slack terms are preferred to be kept at minimal values as demonstrated by the second term to be minimized, Σₖ₌₁^{Q}|ξₖ|. The inclusion of the second term in the minimization operator introduces a tradeoff between adjusting the hyperplane and limiting the slack terms. This tradeoff is controlled by the regularization term λ, which may be considered a hyperparameter of the SVM.

In some aspects, an LSSVM is an extended version of the SVM. In general, the following modifications are made to the SVM to arrive at the LSSVM. First, target values are used instead of threshold values in the constraints. Second, the problem is simplified via the use of equality constraints and the least squares algorithm. With these modifications, the loss function of the LSSVM may be written as

$$L = {\sum }_{i = 1}^{N} {( {α}_{i} - b )}^{2} + λ {\sum }_{i = 1}^{N} {\sum }_{j = 1}^{N} ( {α}_{i} {α}_{j} K ( {x}_{i} , {x}_{j} ) ) , \qquad EQ . 7$$

where αᵢ are Lagrange multipliers, b is a bias term, λ is a regularization parameter, K is a kernel function, i and j and indices operating over the N data points in the training data and xᵢ and xⱼ represent the i^{th} and j^{th} data points, respectively.

In accordance with one or more embodiments, the trained first and second AI models (340, 350) are used to determine an optimal set of operation parameters to optimally operate a pipeline (and, in some instances, a well). For example, the optimal set of operation parameters may establish or maintain a desired flow class. As another example, the optimal set of operation parameters maximize oil production from a well. Upon determining the set of optimal operation parameters, the set of optimal operation parameters may be applied to the pipeline automatically using a pipeline controller (e.g., Pipeline Controller B (408)). In one or more embodiments, pipeline performance (according to some performance metric such as oil production) is continuously monitored by at least one pipeline device (e.g., sensor) to ensure that the determined set of optimal operation parameters improve the pipeline performance metric.

The process of using the trained AI models (340, 350) to determine the set of optimal operation parameters that optimize the operation of the pipeline according to a pipeline performance metric, is summarized in FIG. 7. The pipeline performance metric can quantify one or more aspects of the pipeline or its output such as: oil production; magnitude of flow-induced vibrations in the pipeline; a reduction in irreversible losses in the pipeline at a given flow rate; and the realization of a desired flow class.

In one or more embodiments, the AI models (340, 350) are trained using previously acquired modelling data, the modelling data acquired from historical operating data of one or more pipelines. As previously described, the result of the training procedure(s) is trained first and second AI models (340, 350). The trained first and second AI models (340, 350) may each be described as a function relating the inputs (e.g., flow data) and the output (i.e., pressure gradient). That is, the AI models may each be mathematically represented as pressure gradient=ƒ(flow data), such that, given an input of flow data, the trained AI models (340, 350) may produce a predicted pressure gradient output. The predicted pressure gradients are aggregated to form an aggregated pressure gradient. In accordance with one or more embodiments, a pipeline performance metric is based on the aggregate pressure gradient. Herein, the value of the pipeline performance, according to a given pipeline performance metric, is represented as P and it is assumed that the given pipeline performance metric is configured such that increased values of P represent better pipeline performance. Thus, representing the pipeline performance metric as a function g, the pipeline performance can be given as P=g (aggregate pressure gradient) or P=g(first AI model (flow data), second AI model (flow data))=g(RBFNN (flow data), LSSVM (flow data)). Thus, with trained AI models an optimization wrapper (depicted as Block 702) is used to invert the models to determine the set of optimal operation parameters that maximize the pipeline performance P according to a pipeline performance metric. Mathematically, the optimization takes the form:

$${arg max}_{{S}_{1}} P \qquad EQ . 8$$

$$subject to : device constraints$$

where the set of operation parameters is denoted as S₁. Thus, the optimization wrapper (702) maximizes the pipeline performance, according to a pipeline performance metric, over the set of operation parameters. The optimization wrapper (702), when applied to a trained AI models parameterized by the set of operation parameters, returns a set of optimal operation parameters. Optimization algorithms that may be employed by the optimization wrapper (702) include, but are not limited to: genetic algorithm, Newton conjugate gradient (Newton-CG), Broyden-Fletcher-Goldfarb-Shanno (BFGS), and limited-memory BFGS (L-BFGS) algorithms.

One with ordinary skill in the art will appreciate that maximization and minimization may be made equivalent through simple techniques such as negation. As such, the choice to represent the optimization as a maximization as shown in EQ. 8 does not limit the scope of the present disclosure. Whether done through minimization or maximization, the optimization wrapper (702) identifies the set (or sets) of operation parameters that optimize pipeline performance based on the trained AI models (340, 350).

Additionally, it is recognized that a pipeline (and, in some instances, an associated well) may be subject to constraints, such as safety limits imposed on various devices of the pipeline (and well). For example, it may be determined that in order for a pipeline to operate safely, pressure, as measured by a given sensor of the pipeline, should not exceed a prescribed value. In FIG. 7, the constraints are referenced as device constraints. In one or more embodiments, the optimization wrapper (702) cannot elect any set of operation parameters that cause any portion of the pipeline (or associated systems such as a well, if applicable) to exceed predefined device constraints.

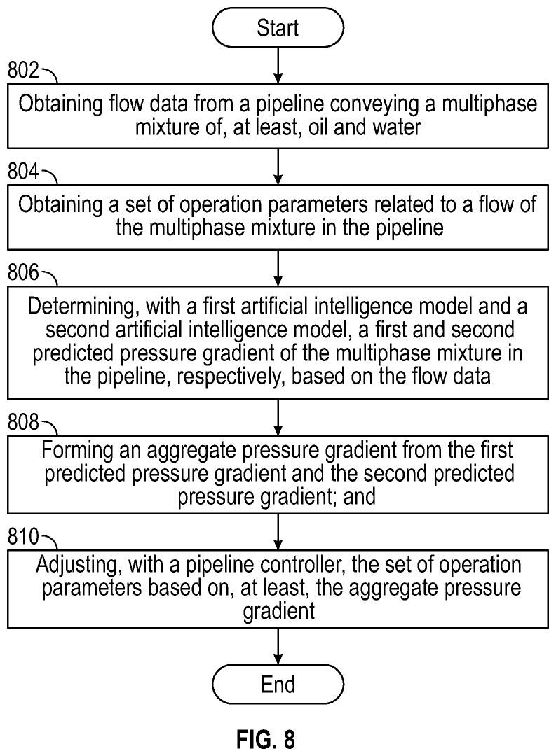

The process of evaluating flow data and determining an aggregate pressure gradient using the first AI model (340) and the second AI model (350) is summarized in the flowchart of FIG. 8. In Block 802, flow data from a pipeline is obtained. The pipeline is conveying a multiphase mixture consisting of at least oil and water. In accordance with one or more embodiments, the flow data describes characteristics of the pipeline and thermophysical properties of the multiphase mixture. In one or more embodiments, the flow data includes a diameter of the pipeline, an inner surface roughness of the pipeline, an oil and water slip velocity, and an oil viscosity. In Block 804, a set of operation parameters related to a flow of the multiphase mixture in the pipeline is obtained. In one or more embodiments, the set of operation parameters includes a set of pipeline parameters (e.g., a state of a valve on the pipeline). In general, the set of pipeline parameters govern the flow of the multiphase mixture in the pipeline (e.g., adjustment of the pipeline parameters can directly influence a flow class descriptive of the flow of the multiphase mixture). In some embodiments, the pipeline is part of, or associated with, a well. In these embodiments, the set of operation parameters further includes a set of well control parameters.

In Block 806, a first artificial intelligence (AI) model and a second artificial intelligence (AI) model are used to determine a first predicted pressure gradient and a second predicted pressure gradient in the multiphase mixture, respectively, based on the flow data. In one or more embodiments, the first AI model is a radial basis function neural network (RBFNN). In one or more embodiments, the second AI model is a least squares support vector machine (LSSVM). In some implementations, the first and second AI models also process or are otherwise dependent on the set of operation parameters. In Block 808, an aggregate pressure gradient is formed from the first predicted pressure gradient and the second predicted pressure gradient. In one or more embodiments, the aggregate pressure gradient is determined by applying an aggregation function to the first and second predicted pressure gradients. In one or more embodiments, the aggregation function is the mean or average function such that the aggregate pressure gradient is the average of the first predicted pressure gradient and the second predicted pressure gradient. In other embodiments, the aggregation function selects one of the first and second predicted pressure gradients based on the flow data and/or the set of operation parameters.

In Block 810, the set of operation parameters are adjusted based on the aggregate pressure gradient. In one or more embodiments, adjustment of the set of operation parameters is made using pipeline controller. In one or more embodiments, the set of operation parameters are adjusted to a set of optimal operation parameters, where the optimization of the operation parameters is performed through evaluation of a pipeline performance metric based on, at least, the aggregate pressure gradient. In one or more embodiments, the pipeline performance is quantified by a quantity (or rate) of oil production. That is, in these embodiments, the set of optimal operation parameters maximize oil production with the pipeline. In other embodiments, a desired pressure gradient is indicated by a user and the set of operation parameters are adjusted iteratively (e.g., using an intelligent design such a Bayesian-based method) to determine a set of operation parameters that results in the desired pressure gradient. In these embodiments, the set of operation parameters can be adjusted “virtually” until the desired set of operation parameters are determined and then the determined set of operation parameters can be applied to the pipeline (e.g., using the pipeline controller).

Other example uses of embodiments of the instant disclosure are as follows. In some implementations, two or more sensors disposed on the pipeline can be used to measure or determine the “actual” pressure gradient in the pipeline (or over a segment of the pipeline). The actual pressure gradient can be compared to the aggregate pressure gradient, determined using the predictions of the first and second AI models based on the flow data. A difference between the actual pressure gradient and the aggregate pressure gradient can be computed, for example, as a mean absolute percentage error. If the difference between the actual pressure gradient and the aggregate pressure gradient exceeds a predefined error threshold, then the pipeline (or associated pipeline components) may be determined to be damaged or otherwise impaired or malfunctioning. For example, if the actual pressure gradient is much larger than the aggregate pressure gradient, this can indicate that there is a blockage in the pipeline. In such instances, repair and/or maintenance activities can be undertaken to restore the pipeline (and/or associated components) to good order.

Embodiments of the present disclosure may provide at least one of the following advantages. As noted, complex interactions between configurable aspects of a pipeline and the multiphase mixture that it conveys exist such that configuring the pipeline for optimal operation is a difficult task. Further, the state and behavior multiphase mixture and the pipeline or systems associated with the pipeline (e.g., a well) can change with time, often requiring continual changes to maintain optimal pipeline operation. By continuously receiving and processing flow data with the trained AI models disclosed herein, the pipeline can be operated in an optimal state, greatly reducing the cost and time required to identify optimal settings. Further, and as previously discussed, traditional methods for determining the pressure gradient in a pipeline are often inaccurate, applicable to only a narrow range of scenarios, and/or are computationally expensive. The data-driven approach described herein using a first and a second AI model for pressure gradient prediction is generally more accurate than traditional methods and, once the AI models are trained, their use is computationally inexpensive. Further, the first and second AI models can provide predictions in real time to allow for up-to-date pipeline operations. By providing quick and accurate predictions of pressure gradients, embodiments disclosed herein can support more informed decision-making in the oil and gas industry, contributing to more efficient operations and optimized production. Additionally, the first and second AI models can be re-trained as more operation data is acquired allowing for continuous learning and improvement. Thus, an improvement over traditional methods is adaptability, where the first and second AI models can quickly learn new and emerging trends in flow behavior. That is, because the first and second AI models can be continually updated and improved as more operation data becomes available, their predictions remain accurate over time. This is in contrast to traditional models, which may become less accurate if conditions change. Moreover, while traditional models may struggle to generalize to different conditions than those under which they were developed, the first and second AI models as described herein can better handle these differences, providing more reliable predictions across a range of conditions. Some traditional methods often require detailed information about the flow conditions and fluid properties of the multiphase mixture, which may not always be available. Thus, another advantage of embodiments disclosed herein is that accurate pressure gradient predictions can be made based on a limited set of readily available flow data. Additionally, the combination and concurrent use of the LSSVM and RBFNN AI models increases prediction accuracy by leveraging the strengths of both models. Accurate pressure gradient predictions, produced in real time according to one or more embodiments disclosed herein enable pipeline operators to better manage pipeline operations, increasing production efficiency and reducing costs. Finally, embodiments of the instant disclosure leverage existing operational data, turning it into valuable insights (e.g., identification of flow data elements with strong, potentially causal, relationships with the behavior of the flow of the multiphase mixture). This can lead to better utilization of data collected during oil production operations.

Embodiments may be implemented on a computer system. FIG. 9 is a block diagram of a computer system (902) used to provide computational functionalities associated with described algorithms, methods, functions, processes, flows, and procedures as described in the instant disclosure, according to one or more embodiments. The illustrated computer (902) is intended to encompass any computing device such as a server, desktop computer, laptop/notebook computer, wireless data port, smart phone, personal data assistant (PDA), tablet computing device, one or more processors within these devices, or any other suitable processing device such as an edge computing device, including both physical or virtual instances (or both) of the computing device. An edge computing device is a dedicated computing device that is, typically, physically adjacent to the process or control with which it interacts. For example, the AI model may be implemented on an edge computing device in order to quickly provide optimal sets of transceiver parameters and well operation parameters to associated devices or their controllers.

Additionally, the computer (902) may include a computer that includes an input device, such as a keypad, keyboard, touch screen, or other device that can accept user information, and an output device that conveys information associated with the operation of the computer (902), including digital data, visual, or audio information (or a combination of information), or a GUI.

The computer (902) can serve in a role as a client, network component, a server, a database or other persistency, or any other component (or a combination of roles) of a computer system for performing the subject matter described in the instant disclosure. In some implementations, one or more components of the computer (902) may be configured to operate within environments, including cloud-computing-based, local, global, or other environment (or a combination of environments).

At a high level, the computer (902) is an electronic computing device operable to receive, transmit, process, store, or manage data and information associated with the described subject matter. According to some implementations, the computer (902) may also include or be communicably coupled with an application server, e-mail server, web server, caching server, streaming data server, business intelligence (BI) server, or other server (or a combination of servers).

The computer (902) can receive requests over network (930) from a client application (for example, executing on another computer (902) and responding to the received requests by processing the said requests in an appropriate software application. In addition, requests may also be sent to the computer (902) from internal users (for example, from a command console or by other appropriate access method), external or third-parties, other automated applications, as well as any other appropriate entities, individuals, systems, or computers.

Each of the components of the computer (902) can communicate using a system bus (903). In some implementations, any or all of the components of the computer (902), both hardware or software (or a combination of hardware and software), may interface with each other or the interface (904) (or a combination of both) over the system bus (903) using an application programming interface (API) (912) or a service layer (913) (or a combination of the API (912) and service layer (913). The API (912) may include specifications for routines, data structures, and object classes. The API (912) may be either computer-language independent or dependent and refer to a complete interface, a single function, or even a set of APIs. The service layer (913) provides software services to the computer (902) or other components (whether or not illustrated) that are communicably coupled to the computer (902). The functionality of the computer (902) may be accessible for all service consumers using this service layer. Software services, such as those provided by the service layer (913), provide reusable, defined business functionalities through a defined interface. For example, the interface may be software written in JAVA, C++, or other suitable language providing data in extensible markup language (XML) format or another suitable format. While illustrated as an integrated component of the computer (902), alternative implementations may illustrate the API (912) or the service layer (913) as stand-alone components in relation to other components of the computer (902) or other components (whether or not illustrated) that are communicably coupled to the computer (902). Moreover, any or all parts of the API (912) or the service layer (913) may be implemented as child or sub-modules of another software module, enterprise application, or hardware module without departing from the scope of this disclosure.

The computer (902) includes an interface (904). Although illustrated as a single interface (904) in FIG. 9, two or more interfaces (904) may be used according to particular needs, desires, or particular implementations of the computer (902). The interface (904) is used by the computer (902) for communicating with other systems in a distributed environment that are connected to the network (930). Generally, the interface (904) includes logic encoded in software or hardware (or a combination of software and hardware) and operable to communicate with the network (930). More specifically, the interface (904) may include software supporting one or more communication protocols associated with communications such that the network (930) or interface's hardware is operable to communicate physical signals within and outside of the illustrated computer (902).

The computer (902) includes at least one computer processor (905). Although illustrated as a single computer processor (905) in FIG. 9, two or more processors may be used according to particular needs, desires, or particular implementations of the computer (902). Generally, the computer processor (905) executes instructions and manipulates data to perform the operations of the computer (902) and any algorithms, methods, functions, processes, flows, and procedures as described in the instant disclosure.

The computer (902) also includes a memory (906) that holds data for the computer (902) or other components (or a combination of both) that can be connected to the network (930). The memory may be a non-transitory computer readable medium. For example, memory (906) can be a database storing data consistent with this disclosure. Although illustrated as a single memory (906) in FIG. 9, two or more memories may be used according to particular needs, desires, or particular implementations of the computer (902) and the described functionality. While memory (906) is illustrated as an integral component of the computer (902), in alternative implementations, memory (906) can be external to the computer (902).

The application (907) is an algorithmic software engine providing functionality according to particular needs, desires, or particular implementations of the computer (902), particularly with respect to functionality described in this disclosure. For example, application (907) can serve as one or more components, modules, applications, etc. Further, although illustrated as a single application (907), the application (907) may be implemented as multiple applications (907) on the computer (902). In addition, although illustrated as integral to the computer (902), in alternative implementations, the application (907) can be external to the computer (902).

There may be any number of computers (902) associated with, or external to, a computer system containing computer (902), wherein each computer (902) communicates over network (930). Further, the term “client,” “user,” and other appropriate terminology may be used interchangeably as appropriate without departing from the scope of this disclosure. Moreover, this disclosure contemplates that many users may use one computer (902), or that one user may use multiple computers (902).

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed is:

1. A method, comprising:
obtaining flow data from a pipeline conveying a multiphase mixture of, at least, oil and water;
obtaining a set of operation parameters related to a flow of the multiphase mixture in the pipeline;
determining, with a first artificial intelligence model and a second artificial intelligence model, a first and second predicted pressure gradient of the multiphase mixture in the pipeline, respectively, based on the flow data;
forming an aggregate pressure gradient from the first predicted pressure gradient and the second predicted pressure gradient; and
adjusting, with a pipeline controller, the set of operation parameters based on, at least, the aggregate pressure gradient.

2. The method of claim 1,
wherein the multiphase mixture is produced by a well,
wherein the set of operation parameters comprises:
a set of well control parameters defining an operation of the well; and
a set of pipeline parameters governing the flow of the multiphase mixture in the pipeline.

3. The method of claim 1, wherein the set of operation parameters comprises:
a set of pipeline parameters governing the flow of the multiphase mixture in the pipeline.

4. The method of claim 1, wherein the flow data comprises:
an oil and water slip velocity relating the velocity of the oil and the velocity of the water of the multiphase mixture;
a diameter of the pipeline;
a roughness of the pipeline; and
a viscosity of the oil of the multiphase mixture.

5. The method of claim 1:
wherein the first artificial intelligence model is a least squares support vector machine,
wherein the second artificial intelligence model is a radial basis function neural network.

6. The method of claim 1, further comprising:
determining, with an optimizer, a set of optimal operation parameters based on the aggregate pressure gradient, wherein the set of optimal operation parameters maximize a production of oil.

7. The method of claim 1, further comprising:
acquiring sensor data, with at least one sensor, the sensor data comprising at least one of a pressure difference between two locations on the pipeline and a production metric; and
determining, based on the sensor data and the aggregate pressure gradient, a blockage or leak in the pipeline.

8. The method of claim 1,
wherein the first and second predicted pressure gradients, determined with the first and second artificial intelligence models, respectively, are further based on the set of operation parameters,
wherein the method further comprises:
iteratively adjusting the set of operation parameters to identify a set of optimal operation parameters that result in a desired aggregate pressure gradient.

9. A system, comprising:
a pipeline that conveys a multiphase mixture of, at least, oil and water; and
a pipeline controller that can configure one or more configurable parameters of the pipeline, the one or more configurable parameters comprised by a set of operation parameters, the pipeline controller configured to:
obtain flow data from the pipeline;
determine, with a first artificial intelligence model and a second artificial intelligence model, a first and second predicted pressure gradient of the multiphase mixture in the pipeline, respectively, based on the flow data;
form an aggregate pressure gradient from the first predicted pressure gradient and the second predicted pressure gradient; and
adjust the set of operation parameters based on, at least, the aggregate pressure gradient.

10. The system of claim 9, further comprising:
a well, wherein the multiphase mixture is produced by a well,
wherein the set of operation parameters comprises:
a set of well control parameters defining an operation of the well; and
a set of pipeline parameters governing the flow of the multiphase mixture in the pipeline.

11. The system of claim 9, wherein the flow data comprises:
an oil and water slip velocity relating the velocity of the oil and the velocity of the water of the multiphase mixture;
a diameter of the pipeline;
a roughness of the pipeline; and
a viscosity of the oil of the multiphase mixture.

12. The system of claim 9:
wherein the first artificial intelligence model is a least squares support vector machine,
wherein the second artificial intelligence model is a radial basis function neural network.

13. The system of claim 9, the pipeline controller further configured to:
determine, with an optimizer, a set of optimal operation parameters based on the aggregate pressure gradient, wherein the set of optimal operation parameters maximize a production of oil.

14. The system of claim 9, the pipeline controller further configured to:
acquire sensor data, with at least one sensor, the sensor data comprising at least one of a pressure difference between two locations on the pipeline and a production metric; and
determine, based on the sensor data and the aggregate pressure gradient, a blockage or leak in the pipeline.

15. A non-transitory computer-readable memory comprising computer-executable instructions stored thereon that, when executed on a processor, cause the processor to perform steps comprising:
obtaining flow data from a pipeline conveying a multiphase mixture of, at least, oil and water;
obtaining a set of operation parameters related to a flow of the multiphase mixture in the pipeline;
determining, with a first artificial intelligence model and a second artificial intelligence model, a first and second predicted pressure gradient of the multiphase mixture in the pipeline, respectively, based on the flow data;
forming an aggregate pressure gradient from the first predicted pressure gradient and the second predicted pressure gradient; and
adjusting, with a pipeline controller, the set of operation parameters based on, at least, the aggregate pressure gradient.

16. The non-transitory computer-readable memory of claim 15,
wherein the multiphase mixture is produced by a well,
wherein the set of operation parameters comprises:
a set of well control parameters defining an operation of the well; and
a set of pipeline parameters governing the flow of the multiphase mixture in the pipeline.

17. The non-transitory computer-readable memory of claim 15, wherein the flow data comprises:
an oil and water slip velocity relating the velocity of the oil and the velocity of the water of the multiphase mixture;
a diameter of the pipeline;
a roughness of the pipeline; and
a viscosity of the oil of the multiphase mixture.

18. The non-transitory computer-readable memory of claim 15:
wherein the first artificial intelligence model is a least squares support vector machine,
wherein the second artificial intelligence model is a radial basis function neural network.

19. The non-transitory computer-readable memory of claim 15, the steps further comprising:
determining, with an optimizer, a set of optimal operation parameters based on the aggregate pressure gradient, wherein the set of optimal operation parameters maximize a production of oil.

20. The non-transitory computer-readable memory of claim 15, the steps further comprising:
acquiring sensor data, with at least one sensor, the sensor data comprising at least one of a pressure difference between two locations on the pipeline and a production metric; and
determining, based on the sensor data and the aggregate pressure gradient, a blockage or leak in the pipeline.
